(19) United States
(12) Patent Application Publication
(10) Pub. No.: US 2009/0186541 A1
(43) Pub. Date: Jul. 23, 2009

(54) Roof panel

(76) Inventors: James Carolan, County Cavan (IE); Gregory Flynn, County Louth (IE)

Correspondence Address: JACOBSON HOLMAN PLLC, 400 SEVENTH STREET N.W., SUITE 600, WASHINGTON, DC, 20004, US

(21) Appl. No.: 11/921,580

(22) PCT Filed: Jun. 13, 2006
(86) PCT No.: PCT/IE2006/000066

§ 371 Date: Dec. 5, 2007

(51) Int. Cl. E04D 3/35; B32B 11/02

(52) U.S. Cl. 442/38; 442/1; 156/79; 442/48

(57) ABSTRACT

A roof panel for a flat or low pitch roof comprises an inner metal sheet liner or decking (2), an outer liner scrim (3) and a body (4) of insulation therebetween. The scrim (3) for receiving a waterproof membrane may be a glass fibre scrim bonded to cellulose/polyester tissue or a bitumen-impregnated scrim.

### INTRODUCTION

The invention relates to a roof panel for forming a low pitch or flat roof.

Insulated membrane based roof decking systems are known. One of the problems associated with known systems is the difficulty in providing a panel which can be used on site with a wide range of different site-applied waterproof membranes. This invention is directed towards providing a roof panel which will address this problem.

### STATEMENTS OF INVENTION

According to the invention there is provided a roof panel for forming a low pitch or flat roof, comprising an inner metal sheet liner, an outer liner, a body of insulation material between the inner liner and the outer liner, wherein the outer liner comprises a scrim for reception of a waterproof covering.

In one embodiment the scrim is a fiber glass scrim applied to a tissue. The tissue with applied fiber glass scrim preferably has a weight of from 70 to 100, 85 to 95 and preferably approximately 90 g/m² of panel.

The scrim may contain from 2 to 4 threads per cm warp.

The scrim may contain from 1 to 3 threads per cm weft.

In one embodiment the scrim contains approximately 3 threads per cm warp and 2 threads per cm weft.

In one embodiment the scrim is formed from a glass fiber of approximately 34 D'tex.

In another embodiment the scrim comprises a bituminous material. The scrim may comprise a support fibre with bitumen coated or impregnated therein. The fibres may be cellulose/textile fibres. The bituminous scrim may have a weight of from 480 to 500 g/m².

In one embodiment the scrim is for reception of a waterproof membrane.

The invention also provides a continuous method for producing a roof panel comprising the steps of:—
leading an inner metal sheet liner to a lay-down bed;
laying down a liquid foam reactant mixture onto the inner liner;
leading a scrim over the foam;
expanding the foam to form an insulating roof panel, the scrim forming a substrate for reception of a waterproof covering.

In one case the scrim is a fibre glass scrim having a weight of from 70 to 100 g/m².

In another case the scrim is a bituminous scrim having a weight of from 480 to 500 g/m².

The invention also provides—a continuous method for producing a roof panel comprising the steps of:—
leading an inner liner to a lay-down bed;
laying down a liquid foam reactant mixture onto the inner liner;
leading a tissue with applied fiber glass scrim having a weight of from 70 to 100 g/m² of board over the foam;
expanding the foam to form an insulating roof panel, the scrim forming a substrate for reception of a waterproof membrane.

The invention also provides a roof panel when manufactured by a method of the invention.

### BRIEF DESCRIPTION OF THE DRAWINGS

The invention will be more clearly understood from the following description thereof given by way of example only, in which:—

FIG. 1 is a cross sectional view of a joint between roof panels according to the invention;

FIG. 2 is a perspective view from above of a roof panel of Fig. 1;

FIG. 3 is a plan view of a fiber glass scrim used in the panel of the invention;

FIG. 4 is a cross-sectional view of a joint between alternative roof panels according to the invention;

FIG. 5 is a perspective view from above of the roof panel of FIG. 4;

FIG. 6 is a plan view of a bituminous scrim used in the panel of FIGS. 4 and 5;

FIG. 7 is a perspective view of another panel of the invention with a fibre glass scrim;

FIG. 8 is a cross-sectional view of a joint between two of the panels of FIG. 7;

FIG. 9 is a perspective view of a further panel of the invention with a bituminous scrim; and

FIG. 10 is a cross-sectional view of a joint between two of the panels of FIG. 9.

### DETAILED DESCRIPTION

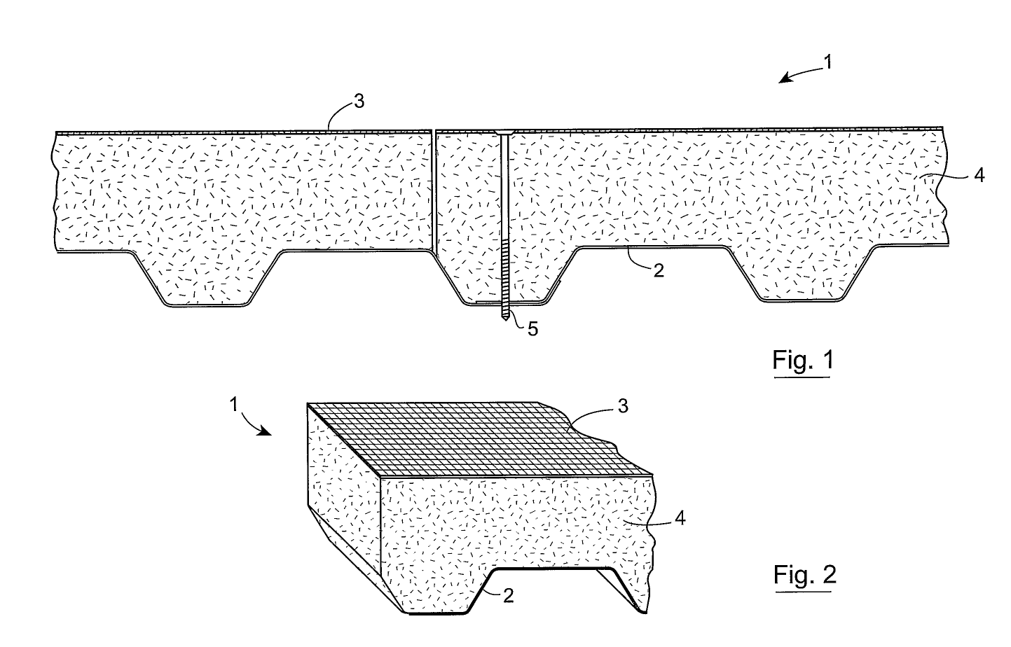

Referring to FIGS. 1 and 2 there is illustrated a roof panel according to the invention for use in forming a low pitch or flat roof.

The roof panel 1 comprises a profiled inner metal sheet liner or decking 2, an outer liner 3, and a body 4 of insulation between the inner liner 2 and outer liner 3. A waterproof membrane (not shown) is bonded to the outer scrim on site.

The inner liner 2 which may be of painted galvanised steel is formed with trapezoidal portions for improved mechanical and insulation performance.

The insulation may be of any suitable foam material such as polyisocyanurate foam.

The outer liner 3 comprises a polyester/cellulose tissue with an applied scrim for reception of a waterproof membrane which is bonded on site to the outer liner 3. The tissue with applied scrim in this case has the following properties:

| Yarn Warp | 34 | tex glass fibre |
|---|---|---|
| Yarn Weft | 34 | tex glass fibre |
| Construction | 3 | threads per cm warp |
| | 2 | threads per cm weft |
| Tissue | 65 | gsm polyester/cellulose |
| Binder | externally plasticised polyvinyl acetate | |
| Tensile Strength Warp | 54 | daN/5 cm |
| Tensile Strength Weft | 34 | daN/5 cm |
| Density | 90.5 | gsm |

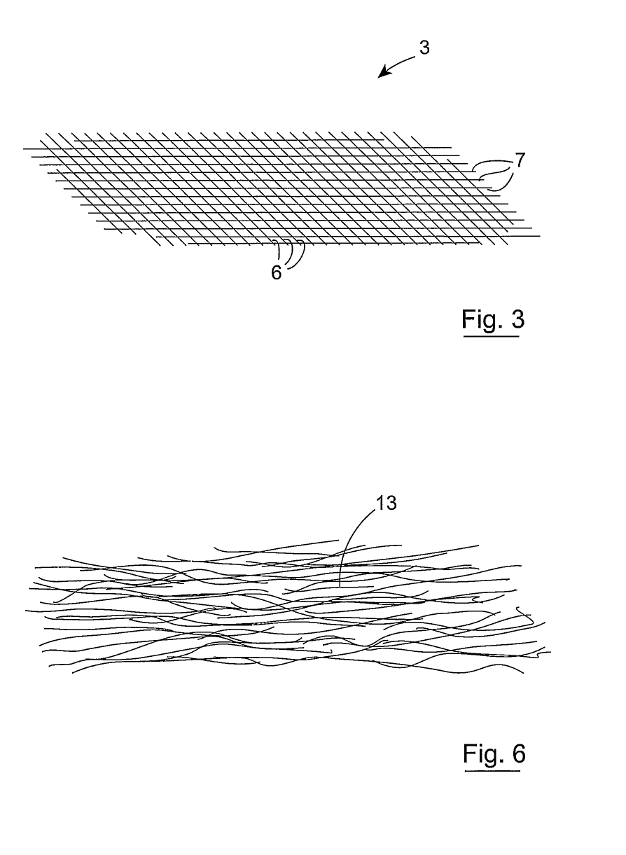

Referring to FIG. 3 the scrim is formed from warp threads 6 and weft threads 7 which are interconnected to form a matrix as diagrammatically illustrated.

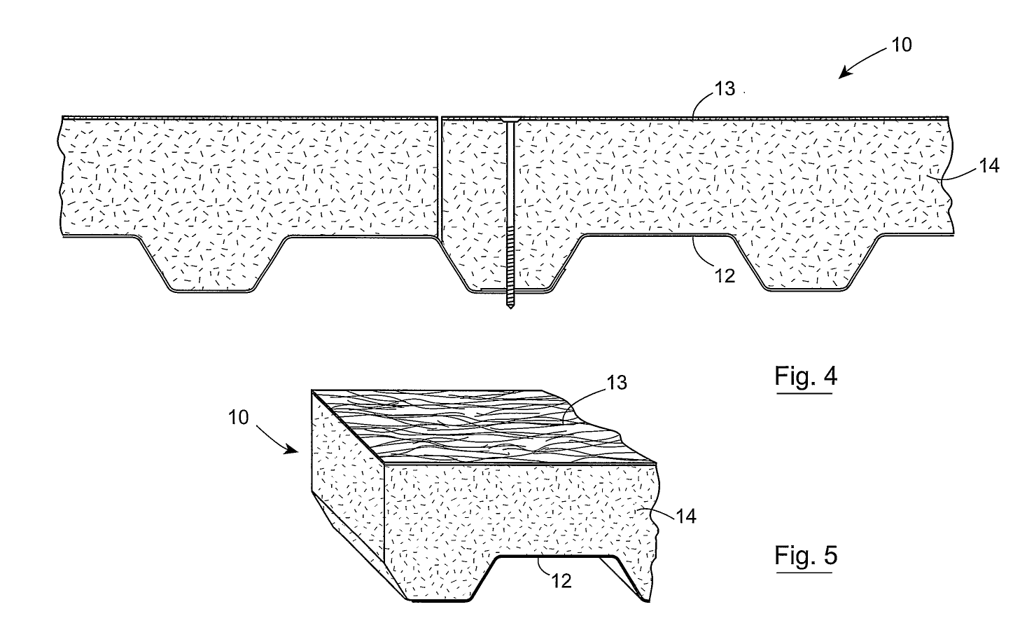

Referring to FIGS. 4 and 5 there is illustrated another roof panel 10 according to the invention for use in forming a low pitch or flat roof.

The roof panel 10 comprises a profiled inner metal sheet liner or decking 12, an outer liner scrim 13, and a body 14 of insulation between the inner liner 12 and outer liner 13. A waterproof membrane (not shown) is bonded to the outer scrim 13 on site.

The inner liner 12 which may be of painted galvanised steel is formed with trapezoidal portions for improved mechanical and insulation performance.

The insulation 14 may be of any suitable foam material such as polyisocyanurate foam.

The outer scrim 13 [FIG. 6] in this case comprises a bituminous material comprising a support fibre of cellulose or textile with bitumen coated or impregnated therein. The bituminous scrim has a weight of from 480 to 500 g/M².

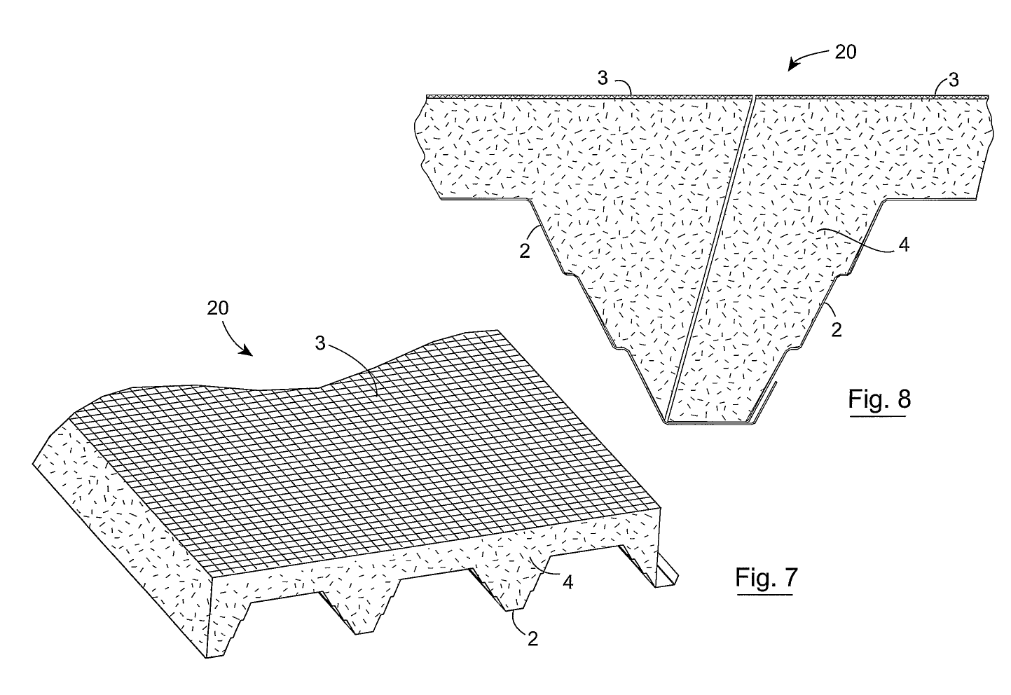

Referring to FIGS. 7 and 8 there is illustrated an alternative panel 20 according to the invention with a fibre glass scrim 3 outer as described above.

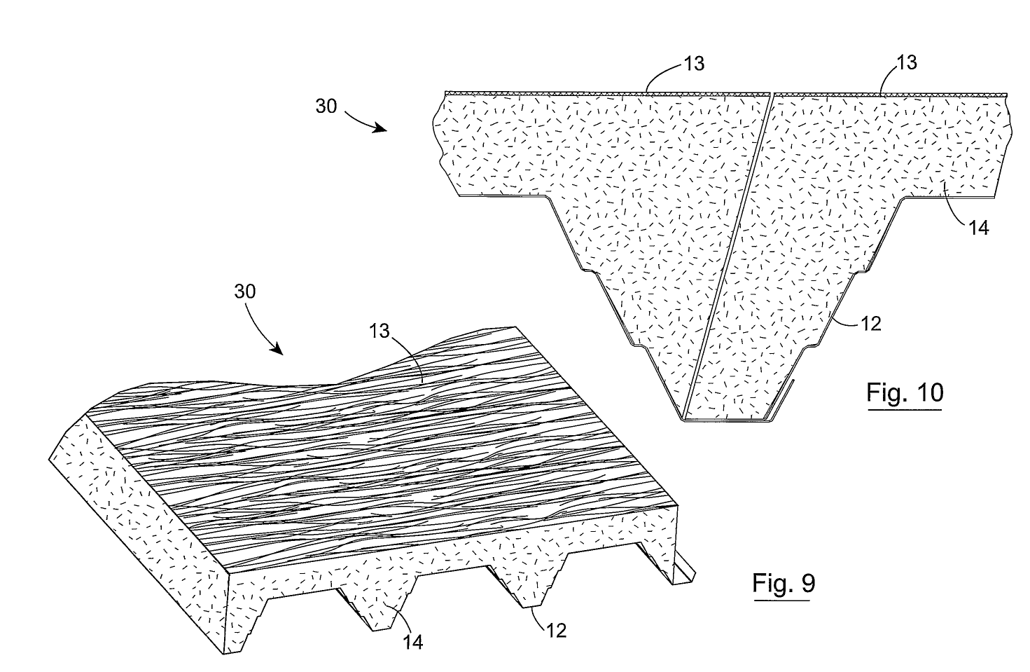

Referring to FIGS. 9 and 10 there is illustrated another panel 30 of the invention with a bituminous scrim outer 13 as described above.

The major advantage of using a scrim to form the outer liner is that is provides a substrate to which any suitable waterproof membrane may be applied on site. The membrane may be of rubber, flexible plastics or PVC and may be heat and/or adhesively bonded to the upper exposed face of the panels. Thus, an installer can use any suitable membrane.

The panels 1 are fixed to underlying supports or purlins and/or adjacent panels by means of fasteners or fixing screws 5. Alternatively, the fixings may be of the self-boring type.

The side edges of panel may be profiled to provide any required joint detail.

The roof panel of the invention is manufactured on a continuous line. The inner metal liner 2 is profiled and then led along a conveyor to a lay-down bed at which liquid foam reactants are laid across the upper face of the liner 2. The scrim 3 is led from a supply reel over the foam. The assembly thus formed is heated in an oven to allow the foam to expand.

The invention is not limited to the embodiments hereinbefore described which may be varied in construction and detail.

1-21. (canceled)

22. A roof panel for forming a low pitch or flat roof, comprising an inner metal sheet liner, an outer liner, a body of insulation material between the inner liner and the outer liner, wherein the outer liner comprises a scrim for reception of a waterproof covering.

23. The panel as claimed in claim 22 wherein the scrim is a fiber glass scrim applied to a tissue.

24. The panel as claimed in claim 23 wherein the tissue of polyester/cellulose.

25. The panel as claimed in claim 23 wherein the tissue with applied fiber glass scrim has a weight of from 70 to 100 g/m² of panel.

26. The panel as claimed in claim 23 wherein the weight of the tissue with applied fiber glass scrim is from 85 to 95 g/m² of panel.

27. The panel as claimed in claim 23 wherein the weight of the tissue with applied fiber glass scrim is approximately 90 g/m² of panel.

28. The panel as claimed in claim 22 wherein the scrim contains from 2 to 4 threads per cm warp.

29. The panel as claimed in claim 22 wherein the scrim contains from 1 to 3 threads per cm weft.

30. The panel as claimed in claim 22 wherein the scrim contains approximately 3 threads per cm warp and 2 threads per cm weft.

31. The panel as claimed in claim 22 wherein the scrim is formed from a glass fiber of approximately 34 D'tex.

32. The panel as claimed in claim 22 wherein the scrim comprises a bituminous material.

33. The panel as claimed in claim 32 wherein the scrim comprises a support fibre with bitumen coated or impregnated therein.

34. The panel as claimed in claim 33 wherein the fibres are cellulose/textile fibres.

35. The panel as claimed in claim 32 wherein the bituminous scrim has a weight of from 480 to 500 g/m².

36. The panel as claimed in claim 22 wherein the scrim is for reception of a waterproof membrane.

37. A continuous method for producing a roof panel comprising the steps of:—
leading an inner liner to a lay-down bed;
laying down a liquid foam reactant mixture onto the inner liner;
leading a scrim over the foam;
expanding the foam to form an insulating roof panel, the scrim forming a substrate for reception of a waterproof covering.

38. The method as claimed in claim 37 wherein the scrim is a fibre glass scrim having a weight of from 70 to 100 g/m².

39. The method as claimed in claim 37 wherein the scrim is a bituminous scrim having a weight of from 480 to 500 g/m².
